(19) United States
(12) Patent Application Publication
(10) Pub. No.: US 2022/0114812 A1
(43) Pub. Date: Apr. 14, 2022

(54) EVENT OCCURRENCE TIME LEARNING DEVICE, EVENT OCCURRENCE TIME ESTIMATION DEVICE, EVENT OCCURRENCE TIME ESTIMATION METHOD, EVENT OCCURRENCE TIME LEARNING PROGRAM, AND EVENT OCCURRENCE TIME ESTIMATION PROGRAM

(71) Applicant: NIPPON TELEGRAPH AND TELEPHONE CORPORATION, Tokyo (JP)

(72) Inventors: Yoshiaki TAKIMOTO, Tokyo (JP); Yusuke TANAKA, Tokyo (JP); Takeshi KURASHIMA, Tokyo (JP); Shuhei YAMAMOTO, Tokyo (JP); Maya OKAWA, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/431,774

(22) PCT Filed: Feb. 7, 2020
(86) PCT No.: PCT/JP2020/004944

§ 371 Date: Aug. 18, 2021

(30) Foreign Application Priority Data
Feb. 20, 2019 (JP) 2019-028825

(51) Int. Cl. G06V 20/40; G06V 10/82; G06N 3/08

(52) U.S. Cl. CPC G06V 20/44; G06N 3/08; G06V 10/82; G06V 20/46

(57) ABSTRACT

Event occurrence is estimated from time series information which is high-dimensional information such as an image.

A hazard estimation unit 11 estimates a likelihood of occurrence of an event according to a hazard function for each of a plurality of time-series image groups including time-series image groups in which no events have occurred and time-series image groups in which events have occurred, each of the plurality of time-series image groups being given an occurrence time of an event in advance, and a parameter estimation unit 12 estimates a parameter of the hazard function such that a likelihood function that is represented by including the occurrence time of an event given for each of the plurality of time-series image groups and the likelihood of occurrence of an event estimated for each of the plurality of time-series image groups is optimized.

### TECHNICAL FIELD

The present disclosure relates to an event occurrence time learning apparatus, an event occurrence time estimation apparatus, an event occurrence time estimation method, an event occurrence time learning program, and an event occurrence time estimation program which estimate the occurrence time of an event using a series of images acquired in time series.

### BACKGROUND ART

In the related art, there is a technique for estimating the time left until an event occurs by analyzing data relating to the time left until an event occurs. For example, in Non Patent Literature 1, the time left until an event occurs (for example, the death of a patient) is estimated using medical images. Specifically, this technique enables estimation by modeling a non-linear relationship between the time until the death of a patient and features included in medical images such as the sizes and locations of lesions using survival analysis and a deep learning technology, especially a convolutional neural network (CNN) (for example, see Non Patent Literature 2).

There is also a technique for estimating the time left until an event occurs from time series information obtained from results of a plurality of clinical tests as in Non Patent Literature 3. Specifically, this technique enables estimation by capturing time-series changes in test results and modeling a relationship between the time-series changes and the time left until an event occurs using survival analysis and a deep learning technology, especially a recurrent neural network (RNN).

### CITATION LIST

### Non Patent Literature

Non Patent Literature 1: Xinliang Zhu, Jiawen Yao, and Junzhou Huang, “Deep convolutional neural network for survival analysis with pathological images”, in Bioinformatics and Biomedicine (BIBM), 2016 IEEE International Conference on, pp. 544-547. IEEE, 2016.
Non Patent Literature 2: Yann LeCun, Leon Bottou. Yoshua Bengio, Patrick Haffner, “Gradient-based learning applied to document recognition”, Proceedings of the IEEE, Vol. 86, No. 11, pp. 2278-2324, 1998.
Non Patent Literature 3: Eleonora Giunchiglia, Anton Nemchenko, Mihaela van der Schaar, “Rnn-surv: A deep recurrent model for survival analysis”, in International Conference on Articial Neural Networks, pp. 23-32. Springer, 2018.

### SUMMARY OF THE INVENTION

### Technical Problem

However, the methods of the related art cannot handle time series information included in a series of images captured at different times. For example, the technique using Non Patent Literature 1 can handle high-dimensional information such as images but cannot handle time-series information. On the other hand, the technique using Non Patent Literature 3 can handle time-series information but cannot handle high-dimensional information such as images.

In addition, these two techniques cannot be simply combined because they have different neural network structures, hazard functions, likelihood functions, and the like. This causes a problem of not being able to perform analysis taking into consideration the movement of objects or the like. For example, when considering a traffic accident as an event, it is not possible to analyze the movement of objects such as whether nearby pedestrians are approaching or moving away and how fast they are. Thus, it is difficult to predict the time left until an accident occurs.

Further, these techniques cannot handle information accompanying a series of images. The accompanying information includes metadata associated with the entire series of images and time-series data typified by sensor data. Non Patent Literature 1 cannot handle both types of data, while Non Patent Literature 3 can handle time-series data but cannot handle metadata. For example, when a traffic accident is considered as an event, the metadata includes attribute information such as the driver's age and the type of the automobile and the time-series data includes the speed or acceleration of the automobile, global positioning system (GPS) location information, the current time, or the like. This information relates to prior knowledge such as the driver's reaction speed and driving tendencies or areas with frequent running out where higher speeds are dangerous. In the related art, these types of information cannot be fully utilized and the occurrence of an accident that does not appear in a series of images until just before running out may be overlooked.

The present invention has been made in view of the above circumstances and it is an object of the present invention to provide an event occurrence time learning apparatus, an event occurrence time estimation apparatus, an event occurrence time estimation method, an event occurrence time learning program, and an event occurrence time estimation program which estimate the occurrence time of an event by learning the occurrence time of an event using a series of images acquired in time series.

### Means for Solving the Problem

An event occurrence time learning apparatus of the present disclosure to achieve the object includes a hazard estimation unit configured to estimate a likelihood of occurrence of an event relating to a recorder of an image, a recorded person, or a recorded object according to a hazard function for each of a plurality of time-series image groups including time-series image groups in which the event has not occurred and time-series image groups in which the event has occurred, each of the plurality of time-series image groups including a series of images and being given an occurrence time of the event in advance, and a parameter estimation unit configured to estimate a parameter of the hazard function such that a likelihood function that is represented by including the occurrence time of the event given for each of the plurality of time-series image groups and the likelihood of occurrence of the event estimated for each of the plurality of time-series image groups is optimized.

Accompanying information may be further given for the time-series image group, and the hazard estimation unit may be configured to estimate the likelihood of occurrence of the event according to the hazard function based on the time-series image group and the accompanying information given for the time-series image group.

The hazard estimation unit may include a plurality of partial hazard estimation units, each being configured to estimate the likelihood of occurrence of the event according to a partial hazard function using at least one of the time-series image group and the accompanying information given for the time-series image group as an input and each having the input or the partial hazard function different from that of another partial hazard estimation unit, and a partial hazard combining unit configured to combine estimated likelihoods of occurrence of the event from the plurality of partial hazard estimation units to obtain an estimate according to the hazard function.

The hazard estimation unit may be configured to extract a feature amount in consideration of a time series of an image from the time-series image group according to the hazard function using a neural network and estimate the likelihood of occurrence of the event based on the extracted feature amount.

An event occurrence time estimation apparatus of the present disclosure includes an input unit configured to receive an input of a target time-series image group including a series of images, a hazard estimation unit configured to estimate a likelihood of occurrence of an event relating to a recorder of an image, a recorded person, or a recorded object for the target time-series image group according to a hazard function using a learned parameter, and an event occurrence time estimation unit configured to estimate an occurrence time of a next event based on the estimated likelihood of occurrence of the event.

An event occurrence time estimation method of the present disclosure includes, at a computer, for each of a plurality of time-series image groups including time-series image groups in which an event relating to a recorder of an image, a recorded person, or a recorded object has not occurred and time-series image groups in which the event has occurred, each of the plurality of time-series image groups including a series of images and being given an occurrence time of the event in advance, estimating a parameter of a hazard function such that a likelihood function that is represented by including the occurrence time of the event and a likelihood of occurrence of the event estimated for each of the plurality of time-series image groups is optimized, receiving an input of a target time-series image group including a series of images, estimating a likelihood of occurrence of the event for the target time-series image group according to a hazard function using the estimated parameter, and estimating an occurrence time of a next event based on the estimated likelihood of occurrence of the event.

An event occurrence time learning program of the present disclosure is a program for causing a computer to estimate a likelihood of occurrence of an event relating to a recorder of an image, a recorded person, or a recorded object according to a hazard function for each of a plurality of time-series image groups including time-series image groups in which the event has not occurred and time-series image groups in which the event has occurred, each of the plurality of time-series image groups including a series of images and being given an occurrence time of the event in advance, and estimate a parameter of the hazard function such that a likelihood function that is represented by including the occurrence time of the event given for each of the plurality of time-series image groups and the likelihood of occurrence of the event estimated for each of the plurality of time-series image groups is optimized.

An event occurrence time estimation program of the present disclosure is a program for causing a computer to receive an input of a target time-series image group including a series of images, estimate a likelihood of occurrence of an event relating to a recorder of an image, a recorded person, or a recorded object for the target time-series image group according to a hazard function using a learned parameter, and estimate an occurrence time of a next event based on the estimated likelihood of occurrence of the event.

### Effects of the Invention

The event occurrence time learning apparatus of the present disclosure having the above features can optimize the hazard function using the likelihood function that is represented by including the occurrence time of the event given for each of the plurality of time-series image groups and the likelihood of occurrence of the event estimated for each of the plurality of time-series image groups. Further, the event occurrence time estimation apparatus of the present disclosure can estimate the occurrence time of the next event using the likelihood of occurrence of an event obtained from the hazard function optimized by the event occurrence time learning apparatus.

In addition to this, by taking into consideration information accompanying time-series images, it is possible to improve the estimation accuracy.

Furthermore, estimation appropriate for inputs of various different types is enabled by obtaining the likelihoods of occurrence of events using a plurality of methods with different inputs or partial hazard functions, combining the estimated likelihoods of occurrence of events, and outputting the combination as a hazard function.

### BRIEF DESCRIPTION OF DRAWINGS

FIG. 1 is a block diagram illustrating a configuration of an event occurrence time learning apparatus and an event occurrence time estimation apparatus according to a first embodiment of the present disclosure.

FIG. 2 is a block diagram illustrating a structure of a neural network according to the first embodiment of the present disclosure.

FIG. 3 is a diagram for explaining a relationship between a hazard function and an event according to the first embodiment of the present disclosure.

FIG. 4 is a flowchart illustrating a flow of processing of the event occurrence time learning apparatus according to the first embodiment of the present disclosure.

FIG. 5 is a flowchart illustrating a flow of processing of the event occurrence time estimation apparatus according to the first embodiment of the present disclosure.

FIG. 6 is a block diagram of the event occurrence time learning apparatus and the event occurrence time estimation apparatus according to the first embodiment of the present disclosure when they are constructed as different apparatuses.

FIG. 7 is a block diagram illustrating a configuration of an event occurrence time learning apparatus and an event occurrence time estimation apparatus according to a second embodiment of the present disclosure.

FIG. 8 is a block diagram illustrating a structure of a neural network according to the second embodiment of the present disclosure.

FIG. 9 is a flowchart illustrating a flow of processing of the event occurrence time learning apparatus according to the second embodiment of the present disclosure.

FIG. 10 is a block diagram of the event occurrence time learning apparatus and the event occurrence time estimation apparatus according to the second embodiment of the present disclosure when they are constructed as different apparatuses.

FIG. 11 is a block diagram illustrating a structure of a neural network according to a third embodiment of the present disclosure.

### DESCRIPTION OF EMBODIMENTS

Hereinafter, embodiments of the present disclosure will be described in detail with reference to the drawings.

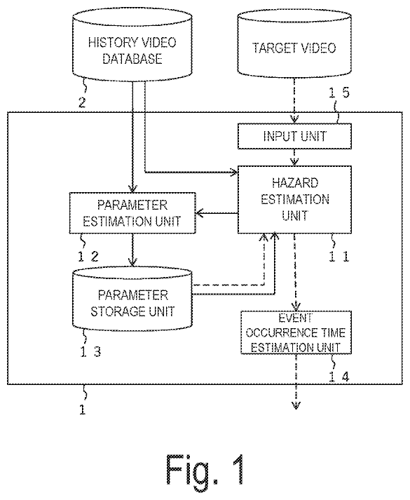

FIG. 1 is a configuration diagram of an event occurrence time learning apparatus and an event occurrence time estimation apparatus according to a first embodiment of the present disclosure. The first embodiment will be described with reference to the case where the event occurrence time learning apparatus and the event occurrence time estimation apparatus are provided in the same apparatus. Hereinafter, a combination of the event occurrence time learning apparatus and the event occurrence time estimation apparatus will be simply referred to as an event occurrence time prediction apparatus.

An event occurrence time prediction apparatus 1 is constructed by a computer or a server computer equipped with well-known hardware such as a processing device, a main storage device, an auxiliary storage device, a data bus, an input/output interface, and a communication interface. By being loaded into a main storage device and then executed by an processing device, various programs constituting an event occurrence time learning program and an event occurrence time estimation program function as each unit in the event occurrence time prediction apparatus 1. In the first embodiment, the various programs are stored in an auxiliary storage device included in the event occurrence time prediction apparatus 1. However, the storage destination of the various programs is not limited to the auxiliary storage device and the various programs may be recorded on a recording medium such as a magnetic disk, an optical disc, or a semiconductor memory or may be provided through a network. Any other component does not necessarily have to be realized by a single computer or server computer and may be realized by being distributed over a plurality of computers connected by a network.

The event occurrence time prediction apparatus 1 illustrated in FIG. 1 includes a hazard estimation unit 11, a parameter estimation unit 12, a parameter storage unit 13, an event occurrence time estimation unit 14, and an input unit 15. In FIG. 1, solid line arrows indicate data communication and directions thereof when the event occurrence time prediction apparatus 1 functions as the event occurrence time learning apparatus and broken line arrows indicate data communication and directions thereof when it functions as the event occurrence time estimation apparatus.

The event occurrence time prediction apparatus 1 is also connected to a history video database 2 via communication means to communicate information therebetween. The communication means may include any known communication means. For example, the event occurrence time prediction apparatus 1 may be connected to the history video database 2 via communication means such as the Internet in which communication is performed according to the Transmission Control Protocol/Internet Protocol (TCP/IP). The communication means may also be communication means according to another protocol.

The history video database 2 is constructed by a computer or a server computer equipped with well-known hardware such as an processing device, a main storage device, an auxiliary storage device, a data bus, an input/output interface, and a communication interface. The first embodiment will be described with reference to the case where the history video database 2 is provided outside the event occurrence time prediction apparatus 1, although the history video database 2 may be provided inside the event occurrence time prediction apparatus 1.

The history video database 2 stores a plurality of time-series image groups, each including a series of images for which event occurrence times are given in advance. Each time-series image group includes a series of images captured at predetermined time intervals. The first embodiment will be described below with reference to the case where each time-series image group is a video shot as an example. Hereinafter, a video shot will be simply referred to as a video V. Further, the history video database 2 stores a set of times when events have occurred for each video V. Events include events relating to a recorder, a recorded person, or a recorded object. Events may be either events that appear in the videos such as events of changes in the recorded person or the recorded object or events that do not appear in the videos such as events relating to the recorder. Hereinafter, a set of times when events have occurred will be referred to as an event occurrence time set E.

The time-series images are not limited to video images captured and recorded by a video camera or the like and may be images captured by a digital still camera at predetermined time intervals.

The recorder may be a person or an animal who or which takes pictures using a device for shooting and recording time-series images such as a video camera or a digital still camera, a robot or a vehicle such as an automobile equipped with a device for shooting and recording, or the like.

Using i as an identifier of the video V, each video Vᵢ is represented by equation (1) below.

[Math. 1]

Vᵢ=[Iᵢⱼ, . . . ,I_{i|V}_{ᵢ}_{|}] (1)

where Iᵢⱼ represents a j-th image included in the video Vᵢ and |Vᵢ| represents the length of the video Vᵢ.

The event occurrence time set Eᵢ of each video Vᵢ is represented by equation (2) below.

[Math. 2]

Eᵢ={eᵢₖ, . . . ,e_{i|E}_{ᵢ}_{|}} (2)

where eᵢₖ represents the occurrence time of a kth event that has occurred in the video Vᵢ and |Eᵢ| indicates the number of events that have occurred in the video Vᵢ. The history video database 2 also includes videos Vᵢ in which no events have occurred, that is, videos where |Eᵢ|=0.

The input unit 15 receives an input of a target time-series image group including a series of images for which event occurrence is to be estimated. The target time-series image group is transmitted from a storage connected to a network or is input from various recording media such as a magnetic disk, an optical disc, and a semiconductor memory.

The first embodiment will be described below with reference to the case where the target time-series image group is a video shot V as an example, similar to the time-series image groups stored in the history video database 2. Hereinafter, the target time-series image group is simply referred to as a target video. The target video is a video V from a certain time in the past to the present and the identifier is c. Similar to the videos in the history video database 2, the target video V_{c} is represented by equation (3) below.

[Math. 3]

V_{c}=[I_{c0}, . . . ,I_{c|V}_{_{c}}_{|}] (3)

Events may or may not occur in the target video V_{c}.

In the first embodiment, a hazard function representing the relationship between a video V and an event is generated using survival analysis and deep learning that uses a neural network (for example, a combination of a CNN and an RNN or a 3DCNN). Through learning, a parameter θ defining the hazard function used for prediction is optimized to estimate event occurrence times.

The parameter storage unit 13 stores the parameter θ of the hazard function. The parameter θ will be described later.

The hazard estimation unit 11 estimates the likelihood of event occurrence for each of a plurality of videos Vᵢ including videos Vᵢ in which no events have occurred and videos Vᵢ in which events have occurred according to the hazard function. Specifically, according to a hazard function using a neural network, the hazard estimation unit 11 extracts feature amounts in consideration of the time series of the images from the video Vᵢ and estimates the likelihood of event occurrence based on the extracted feature amounts.

First, the hazard estimation unit 11 receives a parameter θ of a hazard function from the parameter storage unit 13 and outputs a value of the hazard function utilizing deep learning.

The hazard function is a function that depends on a time t left until an event occurs and l variables (x₁, . . . , xₗ) estimated by deep learning, and when no events have occurred by the time t, represents the likelihood that an event will occur immediately after the time t. The hazard function h(t) is represented, for example, by equation (4) or equation (5) below. Equation (4) represents the case where the number of variables is two and equation (5) represents the case where the number of variables is one. where t in the hazard function h(t) represents a time elapsed from the time when prediction is performed. The number of variables of the hazard function h(t) may be increased as necessary and an equation with the increased number of l variables may be used.

[Math. 4]

h(t)=exp(x₁)exp(x₂)t^{exp(x}^{₂}⁾⁻¹ (4)

[Math. 5]

h(t)=exp(x₁) (5)

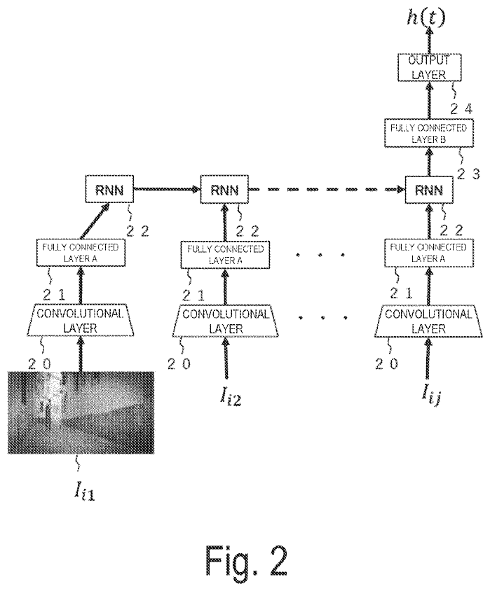

FIG. 2 illustrates an example of a specific neural network structure used with the hazard function. As illustrated in FIG. 2, the neural network of the first embodiment includes units of a convolutional layer 20, a fully connected layer A 21, an RNN layer 22, a fully connected layer B 23, and an output layer 24.

The convolutional layer 20 is a layer for extracting feature amounts from each image Iij (where i=1 to j and j≤|Vᵢ|) in the video Vᵢ. For example, the convolutional layer 20 convolves each image with a 3×3 pixel filter or extracts maximum pixel values of rectangles of a specific size (through max-pooling). For example, the convolutional layer 20 may have a known neural network structure such as VGG described in Reference 1 or may use a parameter learned in advance.

Reference 1: Karen Simonyan and Andrew Zisserman “Very deep convolutional networks for large-scale image recognition”, CoRR, Vol. abs/1409.1556, 2014.

The fully connected layer A 21 further abstracts the feature amounts obtained from the convolutional layer 20. Here, for example, a sigmoid function is used to non-linearly transform the input feature amounts.

The RNN layer 22 is a layer that further abstracts the abstracted features as time-series data. Specifically, for example, the RNN layer 22 receives features as time-series data, causes information abstracted in the past to circulate, and repeats the non-linear transformation. The RNN layer 22 only needs to have a network structure that can appropriately abstract time-series data and may have a known structure, examples of which include the technology of Reference 2.

Reference 2: Kyunghyun Cho, Bart Van Merrienboer, Caglar Gulcehre, Dzmitry Bahdanau, Fethi Bougares, Hol-ger Schwenk, and Yoshua Bengio, “Learning phrase representations using rnn encoder-decoder for statistical machine translation”, arXiv preprint arXiv: 1406. 1078, 2014.

The fully connected layer B 23 transforms a plurality of abstracted feature amounts into a vector of l dimensions corresponding to the number of variables (l) of the hazard function and calculates elements of the vector as values of the variables of the hazard function. Here, the fully connected layer B 23 non-linearly transforms the input feature amounts, for example, using a sigmoid function.

The output layer 24 outputs a value indicating the likelihood that an event will occur immediately after the time t according to the above equation (4) or (5) based on the calculated l-dimensional vector.

The parameter estimation unit 12 estimates a parameter θ of the hazard function such that a likelihood function that is represented by including the occurrence time of an event given for each of the plurality of videos Vᵢ and the likelihood of event occurrence estimated for each of the plurality of videos Vᵢ is optimized.

First, the parameter estimation unit 12 compares the event occurrence time set Eᵢ of each video Vᵢ stored in the history video database 2 with the hazard function output from the hazard estimation unit 11 to estimate a parameter θ. Then, the parameter estimation unit 12 optimizes the parameter θ of the hazard function such that the output of the likelihood function L obtained from the occurrence time eᵢₖ of the kth event and the likelihood of event occurrence at each time tᵢⱼ estimated from the hazard function is maximized. The parameter estimation unit 12 stores the optimized parameter θ of the hazard function in the parameter storage unit 13.

For example, when, for N videos, Δtᵢⱼ and δᵢⱼ are defined using each video Vᵢ and the event occurrence time set Eᵢ of each video Vᵢ, Δtᵢⱼ and δᵢⱼ are represented by equations (6) and (7) below. where tᵢⱼ represents the time of a j-th image Iᵢⱼ of the video Vᵢ.

$$\begin{matrix}[ Math . 6 ] & \\ Δ {t}_{ij} = \{ \begin{matrix}min \{ {c}_{ik} ∈ {E}_{i} \vert {t}_{ij} \leq {e}_{ik} \} - {t}_{ij} , & \{ {e}_{ik} ∈ {E}_{i} \vert {t}_{ij} \leq {e}_{ik} \} \neq ∅ \\ {t}_{i [ {V}_{c} ]} - {t}_{ij} , & otherwise\end{matrix} & ( 6 ) \\ [ Math . 7 ] & \\ {δ}_{ij} = \{ \begin{matrix}1 , & \{ {e}_{ik} ∈ {E}_{i} \vert {t}_{ij} \leq {e}_{ik} \} \neq ∅ \\ 0 , & otherwise\end{matrix} & ( 7 )\end{matrix}$$

From these, a likelihood function L(θ) defined when the current parameter θ is used is represented by equation (8) below.

$$\begin{matrix}[ Math . 8 ] & \\ L ( θ ) = {\prod }_{i = 0}^{N} {\prod }_{j = 0}^{[ {V}_{c} ]} [ {h ( Δ {t}_{ij} \vert {V}_{ij} ; θ )}^{{δ}_{ij}} exp \{ = {\int }_{0}^{Δ {t}_{i , j}} h ( u \vert {V}_{ij} ; θ ) du \} ] & ( 8 )\end{matrix}$$

where

Vᵢⱼ=[Iᵢ₀, . . . ,Iᵢⱼ] [Math. 9]

A specific optimization method can be implemented, for example, by using the logarithm of the likelihood function L(θ) multiplied by −1 as a loss function and minimizing the loss function using a known technique such as backpropagation.

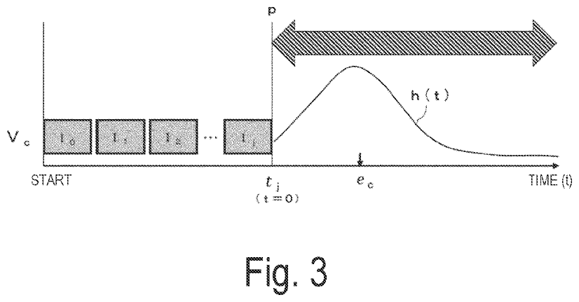

When the learned parameter θ is set in the hazard estimation unit 11 and each image of the target video V_{c} from an image I₀ to an image Iⱼ is input to the hazard estimation unit 11 as illustrated in FIG. 3, the hazard estimation unit 11 obtains the value of the hazard function h(t) at each time from the time tⱼ. The hazard function h(t) obtains the likelihood p of event occurrence in an arrowed range in FIG. 3, that is, at time t elapsed from the time tⱼ of the image Iⱼ.

The event occurrence time estimation unit 14 estimates the occurrence time of the next event based on the value of the hazard function estimated by the hazard estimation unit 11. In prediction, the time e_{c} when the next event will occur can be estimated, for example, by performing a simulation based on the hazard function or by comparing the value of a survival function derived from the hazard function (the probability that no events will occur until t seconds elapse) with a threshold value.

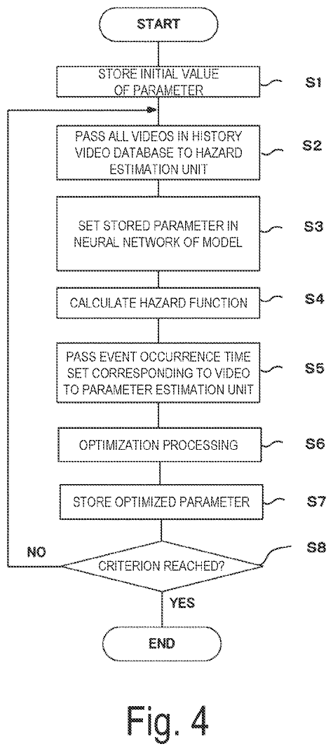

Next, a flow of processing when the event occurrence time prediction apparatus 1 of the first embodiment functions as the event occurrence time learning apparatus will be described with reference to a flowchart of FIG. 4.

First, in step S1, a parameter θ of a hazard function determined using a random number or the like is stored in the parameter storage unit 13 as an initial value of the parameter θ.

Next, in step S2, videos {V₀, . . . , V_{N}} included in the history video database 2 are passed to the hazard estimation unit 11. N is the number of videos included in the history video database 2. Here, a total of N videos Vᵢ in the history video database 2 may be passed to the hazard estimation unit 11 or only a partial set of videos Vᵢ in the history video database 2 may be passed to the hazard estimation unit 11.

In step S3, the hazard estimation unit 11 sets the parameter θ obtained from the parameter storage unit 13 as a neural network parameter of the hazard function.

In step S4, the hazard estimation unit 11 repeats processing of obtaining, for each video Vᵢ (where i is 1 to N), a hazard function h(t|Vᵢⱼ; θ) (see FIG. 3) of each image from a first image Iᵢ₀ to an image Iᵢⱼ at the time tj (where j is 0 to |Vᵢ|). The hazard functions h(t|Vᵢⱼ; θ) obtained for all videos Vi are passed to the parameter estimation unit 12.

In step S5, the parameter estimation unit 12 further receives event occurrence time sets {E₀, . . . , Eₙ} included in the history video database 2 corresponding to the videos Vi.

In step S6, the parameter estimation unit 12 optimizes the parameter θ of the hazard function by maximizing a likelihood function L(θ) obtained from the hazard functions h(t|Vᵢⱼ; θ) and the event occurrence time sets {E₀, . . . , Eₙ} passed to the parameter estimation unit 12.

In step S7, the optimized parameter θ of the hazard function is stored in the parameter storage unit 13.

In step S8, it is determined whether or not a predetermined criterion has been reached. The criterion is, for example, the number of times that has been determined in advance or whether or not the amount of change in the likelihood function is a reference value or less. If the determination of step S8 is negative, the process returns to step S2.

In step S2, the videos {V₀, . . . , V_{N}} included in the history video database 2 are passed to the hazard estimation unit 11 again. The same set of videos Vi may be passed to the hazard estimation unit 11 each time, and a different set of videos Vᵢ may also be passed to the hazard estimation unit 11 each time. For example, a total of N videos Vᵢ in the history video database 2 may be passed to the hazard estimation unit 11 each time. Alternatively, a partial set of videos Vᵢ different from the partial set of videos Vᵢ in the history video database 2 that has been first passed to the hazard estimation unit 11 may be passed to the hazard estimation unit 11 such that partial sets of videos Vᵢ included in the history video database 2 are sequentially passed to the hazard estimation unit 11. The same set of videos Vᵢ may also be passed a plurality of times.

Subsequently, the processing of steps S3 to S7 is executed to obtain a new parameter θ of the hazard function h(t). In step S8, it is determined whether or not the predetermined criterion has been reached and the processing of steps S2 to S7 is repeatedly performed until the predetermined criterion is reached. If the determination in step S8 is affirmative, the optimization ends.

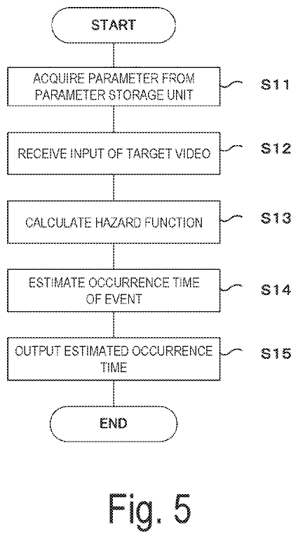

Next, a flow of processing when the event occurrence time prediction apparatus 1 of the first embodiment functions as the event occurrence time estimation apparatus will be described with reference to a flowchart of FIG. 5.

First, in step S11, the optimized parameter θ of the hazard function stored in the parameter storage unit 13 is passed to the hazard estimation unit 11.

In step S12, a target video Vc is input through the input unit 15 and passed to the hazard estimation unit 11.

In step S13, the hazard estimation unit 11 calculates a hazard function h(t|V_{c}) for each time t from the end time of the target video Vc based on each image I_{cj} of the target video V_{c} and passes the calculated hazard function to the event occurrence time estimation unit 14.

In step S14, the event occurrence time estimation unit 14 estimates an event occurrence time ec based on the value of the hazard function h(t|V_{c}) for each time t. Then, in step S15, the event occurrence time estimation unit 14 outputs the estimated occurrence time e_{c}.

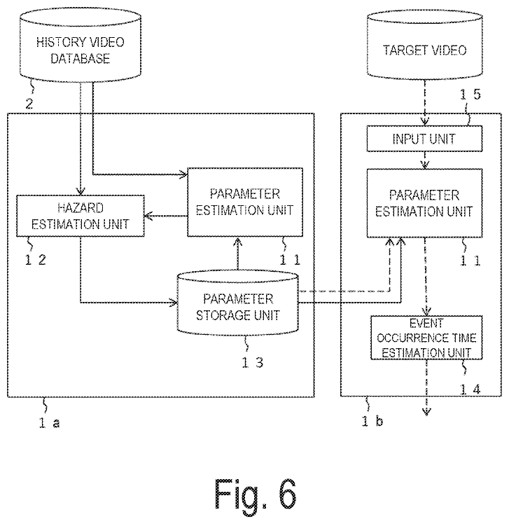

Although the first embodiment has been described with reference to the case where the event occurrence time learning apparatus and the event occurrence time estimation apparatus are constructed as a single apparatus, the event occurrence time learning apparatus 1a and the event occurrence time estimation apparatus 1b may be constructed as different apparatuses as illustrated in FIG. 6. The components and a flow of processing are the same as when the event occurrence time learning apparatus 1a and the event occurrence time estimation apparatus 1b are constructed as the same apparatus and thus are omitted.

In the first embodiment, taking into consideration high-order information of time-series images and time changes thereof while using deep learning and survival analysis makes it possible to estimate the time left until an event occurs. For example, when an event is a traffic accident, taking into consideration the movement of an object makes it possible to determine whether a nearby pedestrian is approaching or moving away, and taking into consideration the speed makes it possible to predict the time left until an accident occurs.

Next, a second embodiment will be described. The second embodiment will be described with reference to the case where the event occurrence time learning apparatus and the event occurrence time estimation apparatus are provided in the same apparatus, similar to the first embodiment. The second embodiment will also be described with reference to the case where time-series image groups are videos, similar to the first embodiment. The second embodiment differs from the first embodiment in that hazard functions are estimated using not only videos but also accompanying information in addition to videos. The same components as those of the first embodiment are denoted by the same reference signs and detailed description thereof will be omitted and only components different from those of the first embodiment will be described in detail.

The history video database 2 of the second embodiment stores accompanying information in addition to videos Vᵢ and event occurrence time sets Eᵢ of the videos Vᵢ. Each video Vᵢ and the event occurrence time set Eᵢ of each video Vᵢ are represented in the same manner as in the first embodiment and thus detailed description thereof will be omitted. The accompanying information is, for example, metadata or time-series data obtained from a sensor simultaneously with the video Vᵢ. Specifically, when videos Vᵢ are videos taken by an in-vehicle camera, the metadata includes attribute information such as the driver's age and the type of the automobile and the time-series data includes the speed or acceleration of the automobile, GPS location information, the current time, or the like.

Hereinafter, the second embodiment will be described with reference to the case where the accompanying information is time-series data. Accompanying information that accompanies an image Iᵢⱼ of each video Vᵢ will be denoted by Aᵢⱼ. The accompanying information Aᵢⱼ is represented by equation (9) below.

[Math. 10]

Aᵢⱼ={aᵢⱼ⁰, . . . ,aᵢⱼ^{|A}^{ᵢⱼ}^{|}} (9)

Here, a^{r}ᵢⱼ represents accompanying information of type r associated with a j-th image Iᵢⱼ of the video Vi and is stored as time-series data in an arbitrary format (for example, a scalar value, a categorical variable, a vector, or a matrix) associated with each image Iᵢⱼ. |Aᵢⱼ| represents the number of types of accompanying information for the image Iᵢⱼ.

In the example using the in-vehicle camera, the accompanying information Aᵢⱼ is, for example, sensor data of speed, acceleration, and position information, and is represented by a multidimensional vector.

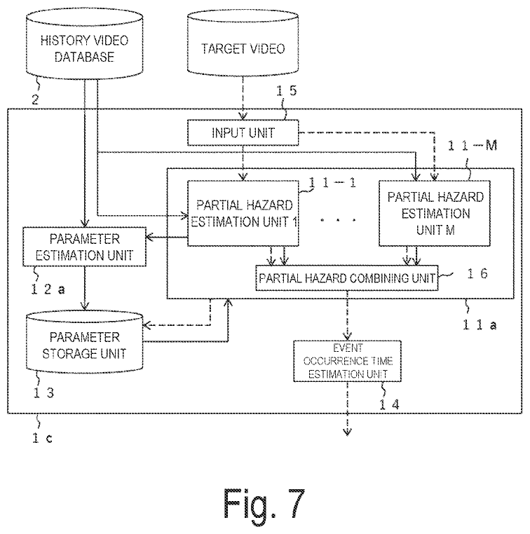

As illustrated in FIG. 7, an event occurrence time prediction apparatus 1c of the second embodiment includes a hazard estimation unit 11a, a parameter estimation unit 12a, a parameter storage unit 13, an event occurrence time estimation unit 14, and an input unit 15. In FIG. 7, solid line arrows indicate data communication and directions thereof when the event occurrence time prediction apparatus 1c functions as the event occurrence time learning apparatus and broken line arrows indicate data communication and directions thereof when it functions as the event occurrence time estimation apparatus. The parameter storage unit 13, the event occurrence time estimation unit 14, and the input unit 15 are similar to those of the first embodiment and thus detailed description thereof will be omitted.

The hazard estimation unit 11a of the second embodiment includes M partial hazard estimation units 11-1, . . . , 11-M and a partial hazard combining unit 16.

Each of the partial hazard estimation units 11-1, . . . , 11-M uses at least one of each video Vi and accompanying information Aᵢⱼ given for the video Vi as an input to estimate the likelihood of event occurrence according to a partial hazard function hₘ(t). Here, m is an identifier of the partial hazard estimation unit 11-1, . . . , 11-M. Each of the plurality of partial hazard estimation units 11-1, . . . , 11-M takes at least one of each video Vᵢ and accompanying information Aᵢⱼ given for the video Vᵢ as an input.

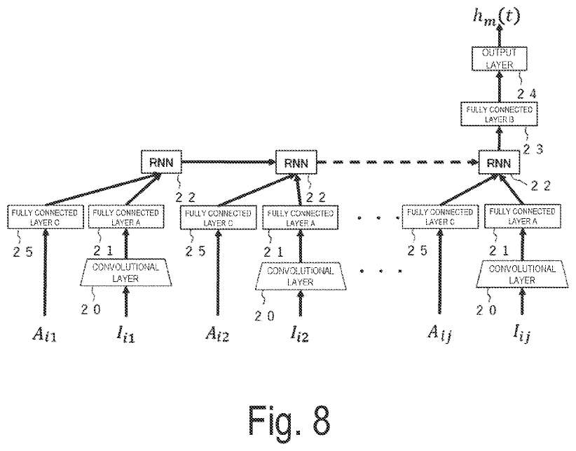

FIG. 8 illustrates an example of a structure of a neural network where hazard functions are obtained using time-series data. Here, a case where feature amounts of accompanying information and feature amounts of an image are input will be described as an example. As illustrated in FIG. 8, the neural network of the second embodiment includes units of a fully connected layer C 25 that takes accompanying information Aᵢⱼ of time-series data as an input in addition to units of a convolutional layer 20, a fully connected layer A 21, an RNN layer 22, a fully connected layer B 23, and an output layer 24. The units of the convolutional layer 20, the fully connected layer A 21, the RNN layer 22, the fully connected layer B 23, and the output layer 24 are similar to those of the first embodiment and thus detailed description thereof will be omitted.

The fully connected layer C 25 transforms the accompanying information Aᵢⱼ represented by a multidimensional vector into an abstract l-dimensional feature vector. Further, it is desirable that the accompanying information Aᵢⱼ be normalized in advance and input to the fully connected layer C 25.

The RNN layer 22 takes the outputs of the fully connected layer A 21 and the fully connected layer C 25 as inputs, such that feature amounts obtained from the image Iᵢⱼ and feature amounts obtained from the accompanying information Aᵢⱼ are input to the RNN layer 22. For example, feature amounts of the accompanying information Aᵢⱼ together with feature amounts of the image Iᵢⱼ included in the video Vi are input to the RNN layer 22 in accordance with the time when the data is obtained.

Further, each of the plurality of partial hazard estimation units 11-1, . . . , 11-M takes an input different from inputs to the other partial hazard estimation units 11-1, . . . , 11-M or has a partial hazard function hₘ(t) different from those of the other. The structure of the neural network differs from that of FIG. 8 described above depending on inputs to the partial hazard estimation units 11-1, . . . , 11-M. That is, when only feature amounts of the accompanying information Aᵢⱼ are input, the structure of the neural network is the structure of FIG. 8 in which the convolutional layer 20 and the fully connected layer A 21 are omitted. When only feature amounts of the image Iᵢⱼ are input, the structure of the neural network is the same as that of FIG. 2.

For example, the video Vᵢ is input to the partial hazard estimation unit 11-1 and the accompanying information Aᵢⱼ is input to the partial hazard estimation unit 11-2. Alternatively, the input information is changed such that the video Vᵢ is input to the partial hazard estimation unit 11-1 and the video Vᵢ and the accompanying information Aᵢⱼ are input to the partial hazard estimation unit 11-2. Further, when a combination of the video Vᵢ and the accompanying information Aᵢⱼ is input to each of the partial hazard estimation unit 11-1 and the partial hazard estimation unit 11-2, the accompanying information Aᵢⱼ input to the partial hazard estimation unit 11-1 and the accompanying information Aᵢⱼ input to the partial hazard estimation unit 11-2 may be information of different types. In the example using the in-vehicle camera, accompanying information Aᵢⱼ of different types include the speed and position information of the automobile. Thus, a combination of the video Vᵢ and the speed of the automobile may be input to the partial hazard estimation unit 11-1 and a combination of the video Vᵢ and the position information of the automobile may be input to the partial hazard estimation unit 11-2.

Further, the partial hazard function hₘ(t) may be changed according to information input to the partial hazard estimation units 11-1, . . . , 11-M, such that it is possible to perform estimation according to the input information. Alternatively, the same video Vi and the same accompanying information Ai may be input to the plurality of partial hazard estimation units 11-1, . . . , 11-M while changing the configuration of the partial hazard function hₘ(t) for each partial hazard estimation unit 11-1, . . . , 11-M, such that the plurality of partial hazard estimation units 11-1, . . . , 11-M can perform estimation from different viewpoints. For example, a neural network may be used for one partial hazard function hₘ(t) while a kernel density estimation value is used for another partial hazard function hₘ(t).

The partial hazard combining unit 16 combines the estimated likelihoods of event occurrence from the plurality of partial hazard estimation units to derive a hazard function h(t). This derivation of the hazard function h(t) may use, for example, a weighted sum or a weighted average of all partial hazard functions hₘ(t) or a geometric average thereof.

The parameter estimation unit 12a compares the event occurrence time set Ei of each video Vᵢ stored in the history video database 2 with the hazard function output from the hazard estimation unit 11a to estimate a parameter θ of the hazard function and stores the estimated parameter θ of the hazard function in the parameter storage unit 13 in the same manner as in the first embodiment described above. Here, the parameter θ of the hazard function includes the parameters θm of the plurality of partial hazard functions hₘ(t).

The likelihood function L of the second embodiment is represented by equation (10) below. Δtᵢⱼ and δᵢⱼ are the same as those of equations (6) and (7) in the first embodiment.

$$\begin{matrix} [ Math . 11 ] & \\ L ( θ ) = \text{?} \text{?} [ h ( Δ {t}_{ij} \vert {V}_{ij} , {A}_{ij} ; θ \text{?} exp \{ - \text{?} h ( u \vert {V}_{ij} , {A}_{ij} ; θ ) du \} ] & ( 10 ) \\ \text{?} \text{indicates text missing or illegible when filed} & \end{matrix}$$

where

Vᵢⱼ=[Iᵢ₀, . . . ,Iᵢⱼ] [Math. 12]

Here, if there is no accompanying information Aᵢⱼ corresponding to the image Iᵢⱼ, Aᵢⱼ is assumed to be empty data. A specific optimization method can be implemented, for example, by using the logarithm of the likelihood function multiplied by −1 as a loss function and minimizing the loss function using a known technique such as backpropagation.

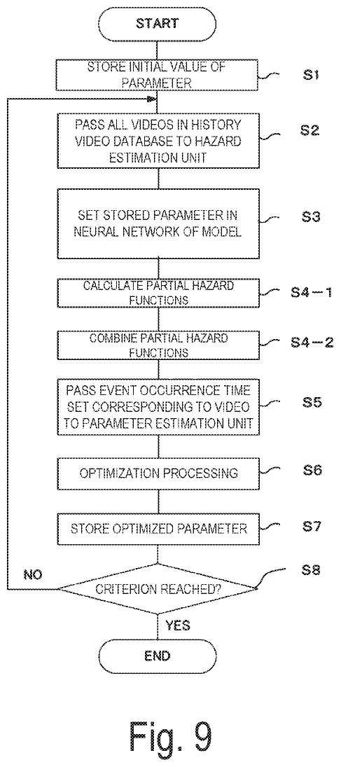

Next, a flow of processing when the event occurrence time prediction apparatus 1c of the second embodiment functions as the event occurrence time learning apparatus will be described with reference to a flowchart of FIG. 9. The same processing as that of the first embodiment is denoted by the same reference signs and detailed description thereof will be omitted.

First, in steps S1 to S3, the same processing as in the first embodiment is performed such that a parameter θ of the hazard function obtained from the parameter storage unit 13 is passed to the hazard estimation unit 11a and set therein as a neural network parameter of the hazard function. Specifically, the parameters Om are set as parameters of the partial hazard functions hₘ(t).

In step S4-1, each of the plurality of partial hazard estimation units 11-1, . . . , 11-M repeats processing of obtaining, for each video Vᵢ (where i is 1 to N), a partial hazard function hₘ(t) of each image from a first image Ii0 to an image Iᵢⱼ at the time tⱼ (where j is 0 to |Vᵢ|). Subsequently, in step S4-2, for each video Vi (where i is 1 to N), values of the partial hazard functions hₘ(t) of each image from the first image Iᵢ₀ to the image Iᵢⱼ at the time tj (where j is 0 to |Vᵢ|) are combined to derive a hazard function h(t) of each image from the first image Ii0 to the image Iij at the time tj (where j is 0 to |Vᵢ|) for each video Vi (where i is 1 to N) and the derived hazard function h(t) is passed to the parameter estimation unit 12.

In steps S5 to S8, the same processing as in the first embodiment is performed. In step S8, it is determined whether or not a predetermined criterion has been reached and the processing of steps S2 to S7 is repeatedly performed until the determination is affirmative. If the determination is affirmative in step S8, the optimization ends.

Next, a flow of processing when the event occurrence time prediction apparatus 1c of the second embodiment functions as the event occurrence time estimation apparatus is similar to that of the first embodiment and thus is omitted.

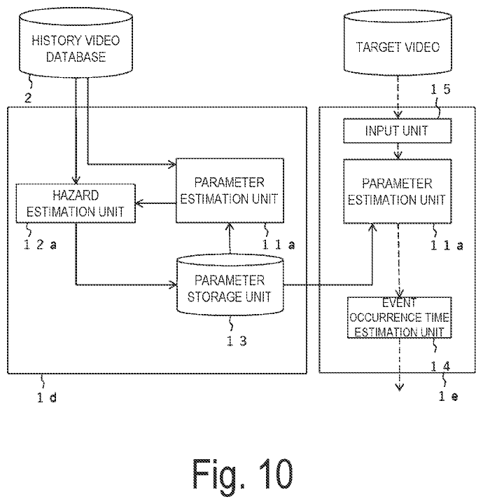

The second embodiment has been described with reference to the case where the event occurrence time learning apparatus and the event occurrence time estimation apparatus are constructed as a single apparatus. In addition, the event occurrence time learning apparatus 1d and the event occurrence time estimation apparatus 1e may be constructed as different apparatuses as illustrated in FIG. 10. The components and a flow of processing are the same as when the event occurrence time learning apparatus 1d and the event occurrence time estimation apparatus 1e are constructed as the same apparatus and thus are omitted.

In the second embodiment, prediction accuracy can be improved by taking into account information accompanying time-series images in addition to the high-order information of the time-series images and time changes thereof. For example, when a traffic accident is considered as an event, it is possible to perform prediction taking into consideration the characteristics of areas such as those with frequent running out and information such as speed and acceleration.

Next, a third embodiment will be described. The third embodiment will be described with reference to the case where a hazard function is estimated using accompanying information similar to the second embodiment. However, the third embodiment differs from the second embodiment in that accompanying information is metadata rather than time-series data and accompanying information such as metadata for the entirety of a video is given.

An event occurrence time prediction apparatus of the third embodiment includes a hazard estimation unit 11a, a parameter estimation unit 12a, a parameter storage unit 13, an event occurrence time estimation unit 14, and an input unit 15, similar to the second embodiment illustrated in FIG. 7. These components are similar to those of the second embodiment and thus detailed description thereof will be omitted and only the differences will be described. The third embodiment also differs from the second embodiment in terms of the structure of a neural network forming a hazard function.

In the third embodiment, the accompanying information is accompanying information Aᵢ that accompanies one video Vᵢ like metadata. In the example using the in-vehicle camera, the metadata is, for example, attribute information such as the driver's age and the type of the automobile. The accompanying information Aᵢ of each video Vi is represented by equation (11) below.

[Math. 13]

Aᵢ={aᵢ⁰, . . . ,aᵢ^{|A}^{ᵢ}^{|}} (11)

Here, a^{r}ᵢ represents r-th accompanying information for the video Vᵢ and a plurality of pieces of accompanying information relating to the entirety of the video is stored in an arbitrary format (for example, a scalar value, a categorical variable, a vector, or a matrix). |Aᵢ| represents the number of pieces of accompanying information for the video Vi.

When the accompanying information Aᵢ is metadata each of the partial hazard estimation units 11-1 . . . . , 11-M uses the video Vᵢ as an input or uses the video Vᵢ and the accompanying information Aᵢ as inputs to estimate the likelihood of event occurrence according to a partial hazard function hₘ(t). Also, similar to the second embodiment, each of the plurality of partial hazard estimation units 11-1, . . . , 11-M takes an input different from inputs to the other partial hazard estimation units 11-1 . . . . , 11-M or has a partial hazard function hₘ(t) different from those of the other.

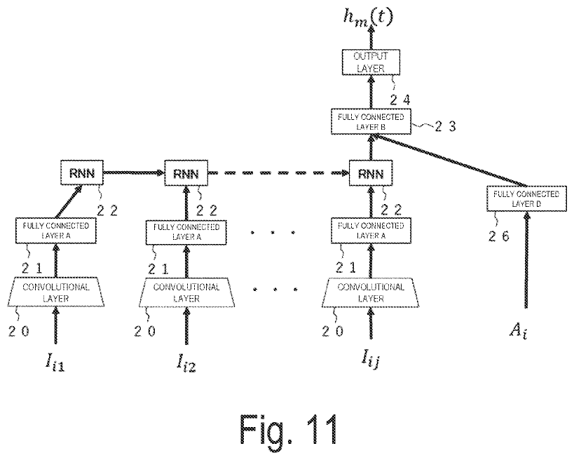

FIG. 11 illustrates an example of a structure of a neural network of the third embodiment. Here, a case where feature amounts of accompanying information and feature amounts of an image are input will be described as an example. As illustrated in FIG. 11, the neural network is provided with units of a fully connected layer D 26 that takes accompanying information Aᵢ as an input in addition to units of a convolutional layer 20, a fully connected layer A 21, an RNN layer 22, a fully connected layer B 23, and an output layer 24 as in the first embodiment.

The fully connected layer D 26 transforms the accompanying information Ai into an abstracted l-dimensional feature vector.

In the second embodiment, feature amounts of the video Iᵢⱼ and feature amounts of the accompanying information Aᵢⱼ are input to the RNN layer 22 via the fully connected layer A 21 and the fully connected layer C 25, respectively. However, in the third embodiment, feature amounts of the accompanying information Aᵢⱼ are input to the fully connected layer B 23 via the fully connected layer D 26, separately from the video Iᵢⱼ.

The structure of the neural network differs from that of FIG. 11 described above depending on inputs to the partial hazard estimation units 11-1, . . . , 11-M. That is, when only feature amounts of the accompanying information Aᵢ are input, the structure of the neural network is the structure of FIG. 11 in which the convolutional layer 20, the fully connected layer A 21, and the RNN layer 22 are omitted. When only feature amounts of the image Iᵢⱼ are input, the structure of the neural network is the same as that of FIG. 2.

The parameter estimation unit 12a compares the event occurrence time set Eᵢ of each video Vᵢ stored in the history video database 2 with the hazard function output from the hazard estimation unit 11a to estimate a parameter θ of the hazard function in the same manner as in the second embodiment described above.

The likelihood function L of the third embodiment is represented by equation (12) below. Δtᵢⱼ and δᵢⱼ are the same as those of equations (6) and (7) in the first embodiment.

$$\begin{matrix} [ Math . 14 ] & \\ L ( θ ) = \text{?} \text{?} [ h ( Δ {t}_{ij} \vert {V}_{ij} , {A}_{i} ; θ \text{?} exp \{ - \text{?} h ( u \vert {V}_{ij} , {A}_{i} ; θ ) du \} ] & ( 12 ) \\ \text{?} \text{indicates text missing or illegible when filed} & \end{matrix}$$

where

Vᵢⱼ=[Iᵢ₀, . . . ,Iᵢⱼ] [Math. 15]

A specific optimization method can be implemented, for example, by using the logarithm of the likelihood function multiplied by −1 as a loss function and minimizing the loss function using a known technique such as backpropagation, similar to the second embodiment.

A flow of processing of the event occurrence time prediction apparatus of the third embodiment is similar to that of the second embodiment and thus detailed description thereof is omitted.

In the third embodiment, the event occurrence time learning apparatus 1d and the event occurrence time estimation apparatus 1e may also be constructed as different apparatuses as illustrated in FIG. 10, similar to the second embodiment.

In the third embodiment, prediction accuracy can be improved by taking into account accompanying information such as metadata in addition to the high-order information of time-series images and time changes thereof. For example, when a traffic accident is considered as an event, it is possible to perform prediction taking into consideration information such as the driver's age and the type of the automobile.

The hazard estimation unit 11a may perform estimation using the partial hazard estimation units of the second embodiment and the partial hazard estimation units of the third embodiment in combination. It is also possible to use a structure in which the fully connected layer B 23 in the structure of the neural network in the second embodiment is provided with the fully connected layer D 26 for inputting feature amounts of the accompanying information A; in the third embodiment.

By combining the partial hazard estimation units of the second embodiment and the partial hazard estimation units of the third embodiment in this way, when a traffic accident is considered as an event, it is possible to perform prediction taking into consideration information such as the driver's age and the type of the automobile in addition to prediction taking into consideration the characteristics of areas such as those with frequent running out and information such as speed and acceleration.

Although the above embodiments have been described with reference to the case where a combination of a CNN and an RNN is used as a neural network, a 3DCNN may also be used.

The present disclosure is not limited to the above embodiments and various modifications and applications are possible without departing from the gist of the present invention.

In the above embodiments, a central processing unit (CPU) which is a general-purpose processor is used as an processing device. It is preferable that a graphics processing unit (GPU) be further provided as needed. Some of the functions described above may be realized using a programmable logic device (PLD) which is a processor whose circuit configuration can be changed after manufacturing such as a field programmable gate array (FPGA), a dedicated electric circuit having a circuit configuration specially designed to execute specific processing such as an application specific integrated circuit (ASIC), or the like.

### REFERENCE SIGNS LIST

1, 1c Event occurrence time prediction apparatus
1a, 1d Event occurrence time learning apparatus
1b, 1e Event occurrence time estimation apparatus
2 History video database
11, 11a Hazard estimation unit
11-1, 11-M Partial hazard estimation unit
12, 12a Parameter estimation unit
13 Parameter storage unit
14 Event occurrence time estimation unit
15 Input unit
16 Partial hazard combining unit
20 Convolutional layer
21 Fully connected layer A
22 RNN layer
23 Fully connected layer B
24 Output layer
25 Fully connected layer C
26 Fully connected layer D

1. An event occurrence time learning apparatus comprising:
a hazard estimator configured to estimate a likelihood of occurrence of an event relating to a recorder of an image, a recorded person, or a recorded object according to a hazard function for each of a plurality of time-series image groups including time-series image groups in which the event has not occurred and time-series image groups in which the event has occurred, each of the plurality of time-series image groups including a series of images and being given an occurrence time of the event in advance; and
a parameter estimator configured to estimate a parameter of the hazard function such that a likelihood function that is represented by including the occurrence time of the event given for each of the plurality of time-series image groups and the likelihood of occurrence of the event estimated for each of the plurality of time-series image groups is optimized.

2. The event occurrence time learning apparatus according to claim 1, wherein accompanying information is further given for the time-series image group, and
wherein the hazard estimator is configured to estimate the likelihood of occurrence of the event according to the hazard function based on the time-series image group and the accompanying information given for the time-series image group.

3. The event occurrence time learning apparatus according to claim 2, wherein the hazard estimator includes:
a plurality of partial hazard estimators, each being configured to estimate the likelihood of occurrence of the event according to a partial hazard function using at least one of the time-series image group and the accompanying information given for the time-series image group as an input and each having the input or the partial hazard function different from that of another partial hazard estimation unit; and
a partial hazard combiner configured to combine estimated likelihoods of occurrence of the event from the plurality of partial hazard estimators to obtain an estimate according to the hazard function.

4. The event occurrence time learning apparatus according to claim 1, wherein the hazard estimator is configured to extract a feature amount in consideration of a time series of an image from the time-series image group according to the hazard function using a neural network and estimate the likelihood of occurrence of the event based on the extracted feature amount.

5. An event occurrence time estimation apparatus comprising:
an input receiver configured to receive an input of a target time-series image group including a series of images;
a hazard estimator configured to estimate a likelihood of occurrence of an event relating to a recorder of an image, a recorded person, or a recorded object for the target time-series image group according to a hazard function using a learned parameter; and
an event occurrence time estimator configured to estimate an occurrence time of a next event based on the estimated likelihood of occurrence of the event.

6. (canceled)

7. A computer-readable non-transitory recording medium storing computer-executable instructions for learning event occurrence time that when executed by a processor cause the computer-executable program to:
estimate, by a hazard estimator, a likelihood of occurrence of an event relating to a recorder of an image, a recorded person, or a recorded object according to a hazard function for each of a plurality of time-series image groups including time-series image groups in which the event has not occurred and time-series image groups in which the event has occurred, each of the plurality of time-series image groups including a series of images and being given an occurrence time of the event in advance; and
estimate, by a parameter estimator, a parameter of the hazard function such that a likelihood function that is represented by including the occurrence time of the event given for each of the plurality of time-series image groups and the likelihood of occurrence of the event estimated for each of the plurality of time-series image groups is optimized.

8. (canceled)

9. The event occurrence time learning apparatus according to claim 2, wherein the hazard estimator is configured to extract a feature amount in consideration of a time series of an image from the time-series image group according to the hazard function using a neural network and estimate the likelihood of occurrence of the event based on the extracted feature amount.

10. The event occurrence time estimation apparatus according to claim 5,
wherein accompanying information is further given for the time-series image group, and
wherein the hazard estimator is configured to estimate the likelihood of occurrence of the event according to the hazard function based on the time-series image group and the accompanying information given for the time-series image group.

11. The event occurrence time estimation apparatus according to claim 5,
wherein the hazard estimator is configured to extract a feature amount in consideration of a time series of an image from the time-series image group according to the hazard function using a neural network and estimate the likelihood of occurrence of the event based on the extracted feature amount.

12. The computer-readable non-transitory recording medium according to claim 7,
wherein accompanying information is further given for the time-series image group, and
wherein the hazard estimator is configured to estimate the likelihood of occurrence of the event according to the hazard function based on the time-series image group and the accompanying information given for the time-series image group.

13. The computer-readable non-transitory recording medium according to claim 7,
wherein the hazard estimator is configured to extract a feature amount in consideration of a time series of an image from the time-series image group according to the hazard function using a neural network and estimate the likelihood of occurrence of the event based on the extracted feature amount.

14. The event occurrence time estimation apparatus according to claim 10,
wherein the hazard estimator includes:
a plurality of partial hazard estimators, each being configured to estimate the likelihood of occurrence of the event according to a partial hazard function using at least one of the time-series image group and the accompanying information given for the time-series image group as an input and each having the input or the partial hazard function different from that of another partial hazard estimation unit; and
a partial hazard combiner configured to combine estimated likelihoods of occurrence of the event from the plurality of partial hazard estimators to obtain an estimate according to the hazard function.

15. The event occurrence time estimation apparatus according to claim 10,
wherein the hazard estimator is configured to extract a feature amount in consideration of a time series of an image from the time-series image group according to the hazard function using a neural network and estimate the likelihood of occurrence of the event based on the extracted feature amount.

16. The computer-readable non-transitory recording medium according to claim 12,
wherein the hazard estimator includes:
a plurality of partial hazard estimators, each being configured to estimate the likelihood of occurrence of the event according to a partial hazard function using at least one of the time-series image group and the accompanying information given for the time-series image group as an input and each having the input or the partial hazard function different from that of another partial hazard estimation unit; and
a partial hazard combiner configured to combine estimated likelihoods of occurrence of the event from the plurality of partial hazard estimators to obtain an estimate according to the hazard function.

17. The computer-readable non-transitory recording medium according to claim 12,
wherein the hazard estimator is configured to extract a feature amount in consideration of a time series of an image from the time-series image group according to the hazard function using a neural network and estimate the likelihood of occurrence of the event based on the extracted feature amount.
